(19) United States
(12) Patent Application Publication
(10) Pub. No.: US 2022/0013836 A1
(43) Pub. Date: Jan. 13, 2022

(54) POUCH TYPE BATTERY CARTRIDGE AND POUCH TYPE BATTERY PACK COMPRISING SAME

(71) Applicant: AMOGREENTECH CO., LTD., Gimpo-si, Gyeonggi-do (KR)

(72) Inventor: Seung Jae HWANG, Gimpo-si, Gyeonggi-do (KR)

(73) Assignee: AMOGREENTECH CO., LTD., Gimpo-si, Gyeonggi-do (KR)

(21) Appl. No.: 17/297,106

(22) PCT Filed: Nov. 22, 2019
(86) PCT No.: PCT/KR2019/016082

§ 371 Date: May 26, 2021

(30) Foreign Application Priority Data
Nov. 27, 2018 (KR) 10-2018-0148486
Nov. 27, 2018 (KR) 10-2018-0148492
Nov. 21, 2019 (KR) 10-2019-0150371

(51) Int. Cl. H01M 50/202; H01M 50/244; H01M 50/211; H01M 10/6555; H01M 10/653; H01M 50/264; H01M 10/647; H01M 10/613

(52) U.S. Cl. CPC H01M 50/202; H01M 50/244; H01M 50/211; H01M 10/613; H01M 10/653; H01M 50/264; H01M 10/647; H01M 10/6555

(57) ABSTRACT

A pouch type battery cartridge is provided. A pouch type battery cartridge according to an exemplary embodiment of the present invention comprises: a cartridge body having an accommodating space, of which both sides are opened, so as to accommodate at least one pouch type battery, and including a first guide member facing a side surface of the pouch type battery accommodated in the accommodation space; a heat dissipation plate coupled to the cartridge body so as to cover one opened side of the accommodating space; and a pair of busbars coupled to one side of the cartridge body so as to be connected to a terminal of the pouch type battery.

### TECHNICAL FIELD

The present invention relates to a battery cartridge and a pouch type battery pack including the same.

### BACKGROUND ART

Batteries are used as energy sources for various products such as electric vehicles, drones, portable phones, laptops, and digital cameras. Lithium secondary batteries having a high energy density and capable of being driven to produce high power are being used as such batteries.

The lithium secondary batteries may be manufactured in the form of a thin pouch and have the advantage of realizing a high-capacity battery even in a small area by connecting a plurality of pouch-type batteries.

Such pouch-type batteries generally have a form in which an electrode assembly is packaged inside a sheet-formed exterior material using aluminum and polymer resin, and thus the pouch-type batteries do not have great mechanical rigidity. Thus, in order to configure a battery module including a plurality of pouch-type batteries, a cartridge is used to easily stack the plurality of pouch-type batteries while protecting the batteries from external shock.

However, when the plurality of pouch-type batteries are stacked and connected to each other, the capacity increases, but the heating temperature of the batteries may also increase, and when the heating temperature of the batteries becomes higher than an allowable temperature, the batteries may explode or be ignited as well as being degraded.

Accordingly, a technique is required to efficiently dissipate heat generated in the batteries when the batteries are charged and discharged.

### DISCLOSURE

### Technical Problem

The present invention is directed to providing a pouch-type battery cartridge and a pouch-type battery pack including the same which may efficiently dissipate heat generated by a battery during charging/discharging of the battery.

### Technical Solution

One aspect of the present invention provides a pouch-type battery cartridge including a cartridge body that has an accommodation space with two open surfaces to accommodate at least one pouch-type battery and includes a first guide member facing a side surface of the pouch-type battery accommodated in the accommodation space, a heat dissipation plate coupled to the cartridge body to cover one open surface of the accommodation space, and a pair of bus bars coupled to one side of the cartridge body to be connected to a terminal of the pouch-type battery.

The first guide member may include a plastic material having a heat radiation property and an insulation property.

The cartridge body may include a second guide member, which is disposed to be spaced apart from the first guide member and faces the first guide member, and a pair of third and fourth guide members connecting both ends of the first guide member and both ends of the second guide member to each other, and each of the first to fourth guide members may include a plastic material having a heat radiation property and an insulation property.

The cartridge body may include at least one elastic member protruding from one surface of the first guide member toward the accommodation space, and the elastic member may be in contact with a side surface of the pouch-type battery when the pouch-type battery is accommodated in the accommodation space.

The cartridge body may have a predetermined area so as to include at least one arrangement hole formed to pass through the first guide member, and the elastic member may be coupled to the first guide member through the arrangement hole. In this case, the elastic member may include a polymer resin including thermally conductive fillers.

The heat dissipation plate may include a first plate having a plate shape and covering one open surface of the accommodation space and a second plate extending in one direction from an end of the first plate to be in surface contact with one surface of the first guide member. The first plate may be in surface contact with one surface of the pouch-type battery when the pouch-type battery is accommodated in the accommodation space.

The heat dissipation plate may be a plate-shaped metal plate. The heat dissipation plate may be a metal plate containing aluminum.

The bus bar may include a terminal part to which the terminal of the pouch-type battery is connected and an extension part extending in one direction from an end of the terminal part and disposed to be in contact with the first guide member.

The pouch-type battery cartridge may further include a heat transfer sheet having a plate shape and disposed on one surface of the heat dissipation plate to be in surface contact with the heat dissipation plate. The heat transfer sheet may be made of a material having a relatively higher thermal conductivity than the heat dissipation plate.

The heat transfer sheet may be a graphite sheet having an insulation-treated surface. The heat transfer sheet may include a plate-shaped graphite sheet and an insulating film member attached to the graphite sheet via an adhesive layer to cover a surface of the graphite sheet.

The heat transfer sheet may include a first part disposed in a part, which covers one open surface of the accommodation space, of an entire area of the heat dissipation plate and a second part extending from the first part and covering a part, which is in surface contact with one surface of the first guide member, of the heat dissipation plate.

Another aspect of the present invention provides a pouch-type battery pack including a plurality of pouch-type battery cartridges, each of which is identical to the pouch-type battery cartridge, a plurality of pouch-type batteries accommodated in the accommodation space, and a mounting frame that fixes the plurality of pouch-type battery cartridges stacked in one direction.

### Advantageous Effects

According to the present invention, by applying various heat dissipation methods, heat generated by a battery can be efficiently dissipated, thereby preventing the degradation of performance of the battery due to heat.

### DESCRIPTION OF DRAWINGS

FIG. 1 is a view illustrating a pouch-type battery cartridge according to the present invention.

FIG. 2 is a view of the pouch-type battery cartridge shown in FIG. 1 when viewed from a different direction.

FIG. 3 is a view illustrating a state in which a heat dissipation plate and a cartridge body are removed from the pouch-type battery cartridge shown in FIG. 2.

FIG. 4 is an exploded view illustrating the pouch-type battery cartridge shown in FIG. 2 according to a first embodiment of the present invention.

FIG. 5 is a cross-sectional view of the pouch-type battery cartridge, which is taken along line A-A of FIG. 2 according to the first embodiment of the present invention.

FIG. 6 is a view illustrating a state in which a plurality of pouch-type battery cartridges are stacked in one direction according to the first embodiment of the present invention.

FIG. 7 is a cross-sectional view schematically illustrating an arrangement relationship between a first guide member and a cooling unit in the state in which the plurality of pouch-type battery cartridges are stacked in the one direction according to the first embodiment of the present invention.

FIG. 8 is an exploded view illustrating the pouch-type battery cartridge shown in FIG. 2 according to a second embodiment of the present invention.

FIG. 9 is a cross-sectional view of the pouch-type battery cartridge, which is taken along line A-A of FIG. 2 according to the second embodiment of the present invention.

FIG. 10 is a conceptual diagram illustrating a detailed configuration of a heat transfer sheet that may be applied to the pouch-type battery cartridge according to the second embodiment of the present invention.

FIG. 11 is a view illustrating a state in which a plurality of pouch-type battery cartridges are stacked in one direction according to the second embodiment of the present invention.

FIG. 12 is a cross-sectional view schematically illustrating an arrangement relationship between a first guide member and a cooling unit in the state in which the plurality of pouch-type battery cartridges are stacked in the one direction according to the first embodiment of the present invention.

FIG. 13 is a view illustrating a pouch-type battery pack using the pouch-type battery cartridge according to the present invention.

### MODES OF THE INVENTION

Hereinafter, embodiments of the present invention will be described in detail with reference to the accompanying drawings so that those skilled in the art to which the present invention pertains may easily implement the present invention. The present invention may be implemented in various different forms and is not limited to the embodiments described herein. In the drawings, parts irrelevant to the description are omitted in order to clearly describe the present invention, and the same reference numerals are assigned to the same or similar components throughout the specification.

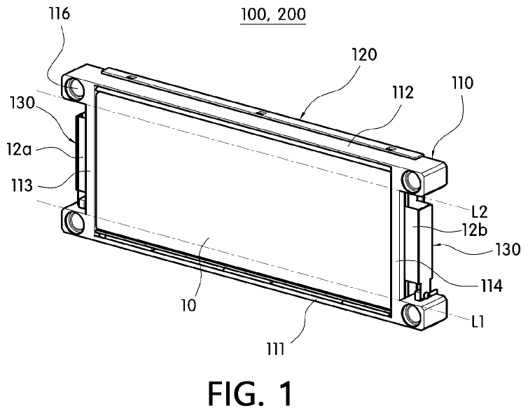

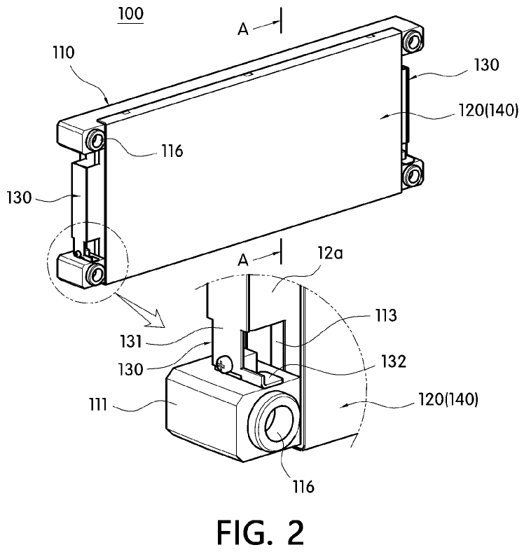

As illustrated in FIGS. 1 and 2, a pouch-type battery cartridge 100 or 200 includes a cartridge body 110, a heat dissipation plate 120, and a pair of bus bars 130.

The cartridge body 110 may accommodate at least one pouch-type battery 10 and may protect the pouch-type battery 10 from an external force. The cartridge body 110 may individually support the respective pouch-type batteries 10 when applied to a battery pack 1000.

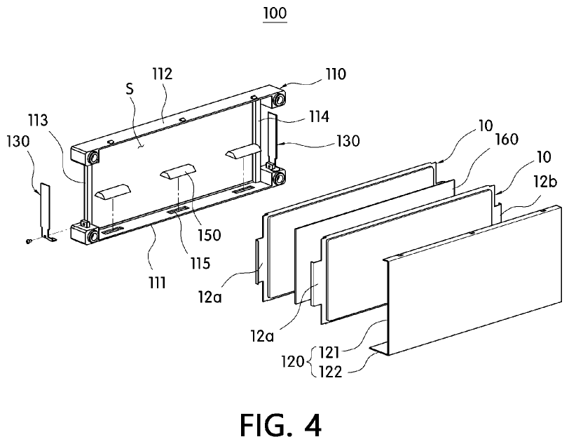

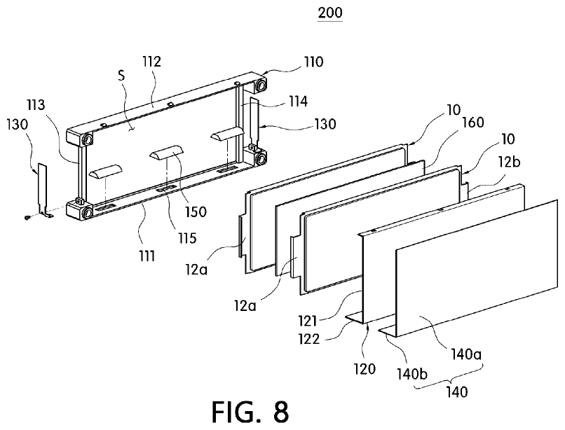

To this end, as illustrated in FIGS. 4 and 8, the cartridge body 110 may be formed of a frame structure having two open sides to accommodate the pouch-type battery 10 while surrounding edges of the pouch-type battery 10.

That is, the cartridge body 110 may be a frame structure having an accommodation space S having two open surfaces.

In detail, the cartridge body 110 may include a pair of first and second guide members 111 and 112, which are disposed to be spaced apart from each other and face each other, and a pair of third and fourth guide members 113 and 114 which are arranged between the first and second guide members 111 and 112, are disposed to be spaced apart from each other, and face each other, wherein one ends of the first and second guide members 111 and 112 may be connected to both ends of the third and fourth guide members 113 and 114.

Here, as illustrated in FIG. 1, the first to fourth guide members 111, 112, 113, and 114 may be divided by imaginary linear lines L1 and L2. In the cartridge body 110, the first guide member 111 may be a portion under the imaginary linear line L1, the second guide member 112 may be a portion above the imaginary linear line L2, and the third guide member 113 and the fourth guide member 114 may be portions between the imaginary linear lines L1 and L2.

Accordingly, the cartridge body 110 may include the accommodation space S defined by the first, second, third, and fourth guide members 111, 112, 113, and 114 and having two open surfaces facing each other, and the accommodation space S may accommodate at least one pouch-type battery 10.

In the present invention, the pouch-type battery 10 may include an electrode assembly in which at least one positive electrode and at least one negative electrode are stacked with a separator interposed therebetween and a pouch-shaped exterior material that encapsulates the electrode assembly together with an electrolyte. Further, the pouch-type battery 10 may be provided so that a pair of terminals 12a and 12b connected to the electrode assembly protrude to the outside of the exterior material. In addition, the pouch-type battery 10 may be a flexible battery. Since the pouch-type battery 10 is widely known, a detailed description thereof will be omitted.

Meanwhile, the cartridge body 110 may include at least one fastening part 116 for fastening other components.

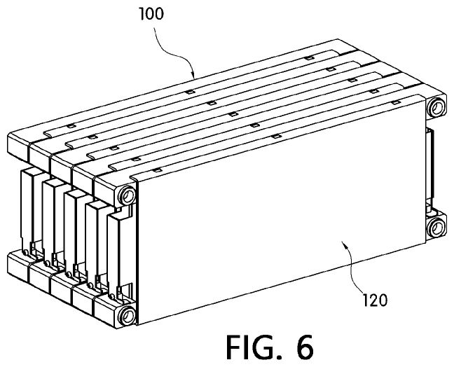

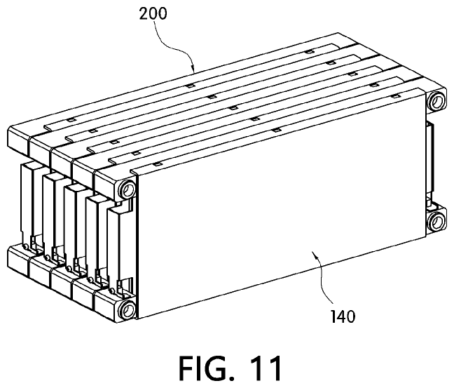

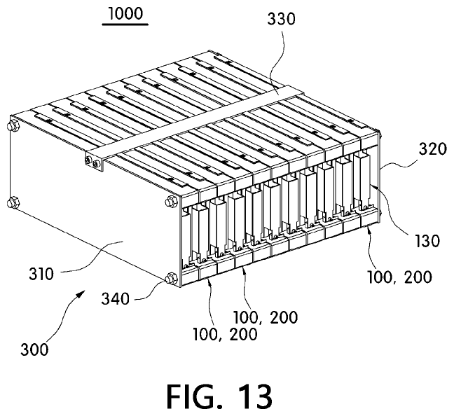

For example, as illustrated in FIG. 1, the fastening part 11 may be a fastening hole formed to pass through an edge of the cartridge body 110. Accordingly, as illustrated in FIGS. 6, 11, and 13, when the pouch-type battery pack 1000 is configured so that the plurality of pouch-type battery cartridges 100 or 200 according to the embodiment of the present invention are stacked in one direction in a state in which the accommodation space S accommodates the pouch-type battery 10, the plurality of pouch-type battery cartridges 100 may be fixed to each other through a fastening member (for example, fastening bar 340 of FIG. 13) fastened to the fastening part 116.

Although it is illustrated in the drawings that the fastening part 116 is formed to pass through the edge of the cartridge body 110, the present invention is not limited thereto, and the fastening part 116 may be formed on a flange side protruding from the edge of the cartridge body 110.

The heat dissipation plate 120 may be coupled to the cartridge body 110 to cover one open surface of the accommodation space S. That is, the heat dissipation plate 120 may be formed of a plate-shaped member having a predetermined area and may be coupled to the cartridge body 110 to cover any one of two open surfaces of the cartridge body 110.

In detail, as illustrated in FIGS. 4, 5, 8, and 9, the heat dissipation plate 120 may include a plate-shaped first plate 121 that covers one open surface of the accommodation space S and a second plate 122 extending in one direction from an end of the first plate 121.

In this way, when the pouch-type battery 10 is accommodated in the accommodation space S, the first plate 121 may be in surface contact with one surface of the pouch-type battery 10 accommodated in the accommodation space S, and the second plate 122 may cover one surface of the first guide member 111.

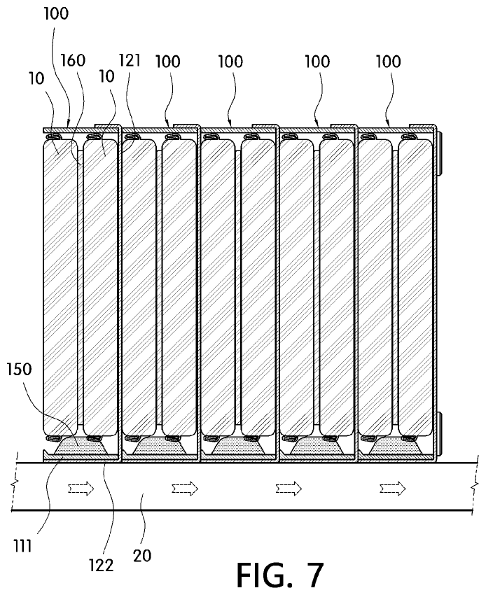

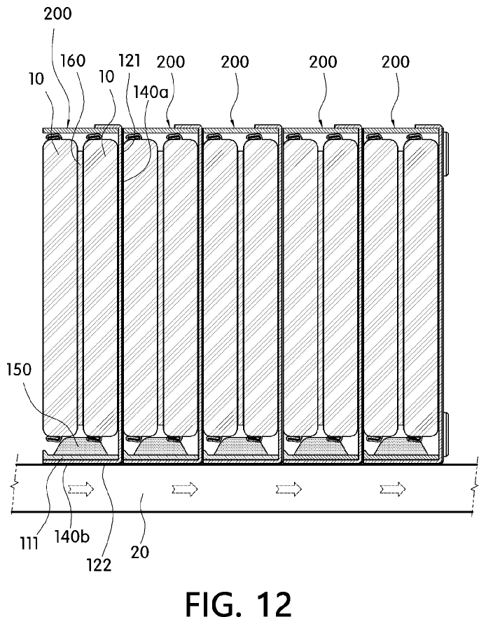

Here, the second plate 122 may have one surface that is in direct contact with a cooling unit 20 such as a cooling chamber or a cooling plate (see FIGS. 7 and 12).

In this case, the heat dissipation plate 120 may dissipate heat generated in the pouch-type battery 10 to the outside.

To this end, the heat dissipation plate 120 may be made of a metal having excellent thermal conductivity so as to rapidly dissipate the heat transferred from the pouch-type battery 10 while protecting the pouch-type battery 10 against an external force.

As an example, the heat dissipation plate 120 may be made of metal including aluminum so as to secure excellent thermal conductivity while reducing a weight thereof. However, the material of the heat dissipation plate 120 is not limited thereto, and any widely known metal used for heat dissipation may be adopted as the material of the heat dissipation plate 120.

Accordingly, the pouch-type battery 10 accommodated in the accommodation space S may be supported through the cartridge body 110 and the heat dissipation plate 20 and thus may be prevented from being deformed and damaged due to an external force.

Further, the heat generated by the pouch-type battery 10 may be transferred to the heat dissipation plate 120 and then rapidly discharged through outside air. In addition, the heat transferred from the pouch-type battery 10 to the heat dissipation plate 120 may be more rapidly dissipated through the second plate 122 in direct contact with the cooling unit 20.

In addition, when the battery pack 1000 including the plurality of pouch-type batteries 10 is configured and when the pouch-type battery cartridge 100 or 200 according to the embodiment of the present invention is used, the battery pack may be easily configured even while preventing deformation of the pouch-type batteries 10.

The pair of bus bars 130 may be coupled to one side of the cartridge body 110. The bus bar 130 may have a shape of a bar having a predetermined length and may be electrically connected to the pouch-type battery 10 accommodated in the accommodation space S.

That is, each of the pair of terminals 12a and 12b of the pouch-type battery 10 may be electrically connected to one of the pair of bus bars 130.

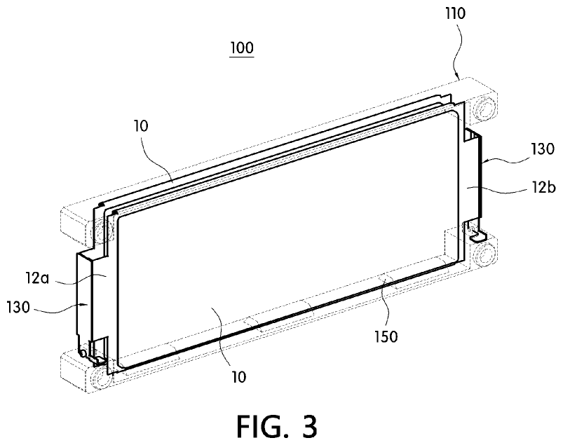

As an example, as illustrated in FIGS. 1 to 3, the pair of bus bars 130 may be arranged on one surfaces of the third guide member 113 and the fourth guide member 114, which face each other, of the cartridge body 110. However, the arrangement position of the bus bars 130 is not limited thereto, and the bus bars 130 may be arranged at proper locations according to the locations of the terminals 12a and 12b of the pouch-type battery 10.

In this case, when the plurality of pouch-type batteries 10 are accommodated in the accommodation space S of the cartridge body 110, the plurality of pouch-type batteries 10 may be connected in parallel through the pair of bus bars 130.

As an example, when two pouch-type batteries 10 are accommodated in the accommodation space S of the cartridge body 110, positive terminals provided in the two pouch-type batteries 10 may be connected to the bus bars 130 arranged on one side of the third guide member 113, and negative terminals provided in the two pouch-type batteries 10 may be connected to the bus bars 130 arranged on one side of the fourth guide member 114.

Thus, when the pouch-type battery pack 1000 is configured using the pouch-type battery cartridges 100 or 200 according to the embodiment of the present invention, the total capacitance of the pouch-type battery pack 1000 may be increased using the plurality of pouch-type batteries 10 connected in parallel.

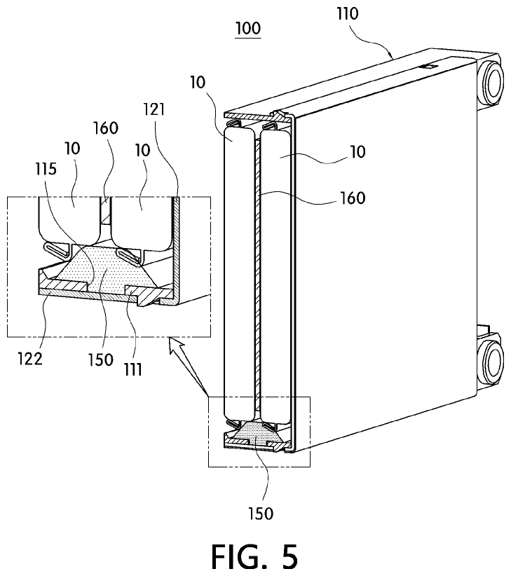

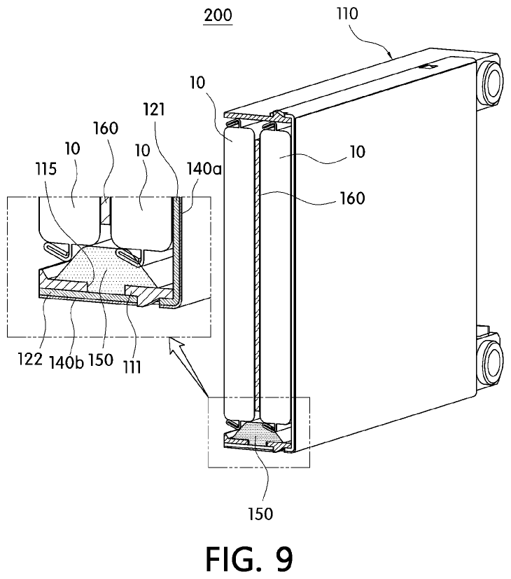

In this case, as illustrated in FIGS. 5 and 9, a buffer member 160 that may absorb an impact may be disposed between the adjacent pouch-type batteries 10. As an example, the buffer member 160 may be an ethylene propylene diene monomer (EPDM) pad.

Meanwhile, in the pouch-type battery cartridge 100 or 200 according to the embodiment of the present invention, various methods for efficiently dissipating heat generated during charging and discharging of the pouch-type batteries 10 may be applied.

As an example, a part of the cartridge body 110, which surrounds the side surfaces of the pouch-type battery 10 accommodated in the accommodation space S, may be formed of a material having a heat radiation property and an insulation property.

As an example, the first guide member 111 may be formed of a plastic material having a heat radiation property and an insulation property. Thus, the heat generated by the pouch-type batteries 10 may be transferred to the first guide member 111 in addition to the heat dissipation plate 120 and then radiated.

Here, the first guide member 111 may be in surface contact with the second plate 122 of the heat dissipation plate 120 that is in direct contact with the cooling unit 20 (see FIGS. 7 and 12).

Accordingly, in the pouch-type battery cartridges 100 or 200 according to the embodiment of the present invention, the heat generated by the pouch-type batteries 10 may be smoothly transferred to the first guide member 111 formed of a plastic material having a heat radiation property and an insulation property and then rapidly radiated through the cooling unit 20.

Here, in the cartridge body 110, some or all of the second to fourth guide members 112, 113, and 114 in addition to the first guide member 111 may be formed of a plastic material having a heat radiation property and an insulation property.

Further, although it is illustrated in the drawing that the second plate 122 of the heat dissipation plate 120 is disposed between the first guide member 111 and the cooling unit 20, the present invention is not limited thereto, and the one surface of the first guide member 111 may be in direct surface contact with the cooling unit 20.

In this case, as illustrated in FIGS. 5 and 9, the cartridge body 110 may include at least one elastic member 150 disposed between the first guide member 111 and the side surface of the pouch-type battery 10.

Here, the elastic member 150 may transfer the heat generated by the pouch-type battery 10 to the first guide member 111 formed of a plastic material having a heat radiation property and an insulation property and may absorb an impact caused by an external force through elastic deformation.

As an example, the elastic member 150 may be formed of a polymer resin containing thermally conductive fillers, and the elastic member 150 may be arranged in the first guide member 111 to protrude from one surface of the first guide member 111 to the accommodation space S.

In this way, when the pouch-type battery 10 is disposed in the accommodation space S, at least a part of the elastic member 150 may be in contact with the side surface of the pouch-type battery 10.

Thus, the elastic member 150 may support the side surface of the pouch-type battery 10 by filling an empty space, which may be formed between the pouch-type battery 10 and the first guide member 111, and may connect the side surface of the pouch-type battery 10 and the one surface of the first guide member 111.

Accordingly, the elastic member 150 can prevent damage to the pouch-type battery 10 through buffering when an external force is generated, and the heat generated by the pouch-type battery 10 may be smoothly transferred, through the elastic member 150, to the first guide member 111 formed of a plastic material having an insulation property and a heat radiation property.

Here, the cartridge body 110 may have a predetermined area so as to include at least one arrangement hole 115 formed to pass through the first guide member 111, and the elastic member 150 may be coupled to the first guide member 111 by being partially inserted into the arrangement hole 115.

Further, the thermally conductive filler may be a non-conductive filler such as alumina, boron nitride, aluminum nitride, or silicon carbide or may be a conductive filler such as graphite, nanocarbon, graphene, silver powder, or copper powder. However, when high reliability for electrical insulation is required, a non-conductive filler may be used as the thermally conductive filler.

In addition, the polymer resin may be a polymer resin such as raw silicone rubber, ethylene propylene diene rubber, thermoplastic polyolefin synthetic rubber, acrylate rubber, or thermoplastic polyurethane rubber.

However, the thermally conductive filler and the polymer resin are not limited thereto, and various widely known thermally conductive fillers and polymer resins may be used as long as the thermally conductive fillers and polymer resins may secure a heat radiation property.

Meanwhile, when at least a part of the cartridge body 110 is formed of a plastic material having an insulation property and a heat radiation property, the bus bars 130 may be coupled to the cartridge body 110 to be in direct contact with the part of the cartridge body 110 formed of a plastic material having an insulation property and a heat radiation property.

That is, as illustrated in an enlarged view of FIG. 2, the pair of bus bars 130 coupled to one surfaces of the third guide member 113 and the fourth guide member 114, which face each other, of the cartridge body 110 may each include a terminal part 131 having a predetermined length and an extension part 132 extending in one direction from an end of the terminal part 131.

In this case, the extension part 132 may be coupled to the cartridge body 110 to be in direct contact with the part of the cartridge body 110 formed of a plastic material having an insulation property and a heat radiation property.

Here, the extension part 132 may be a plate-shaped member having a predetermined area, the terminal part 131 may be disposed on one surfaces of the third guide member 113 and the fourth guide member 114, and the terminals 12a and 12b of the pouch-type battery 10 may be connected to the terminal part 131 through a method such as a welding method.

Further, the part of the cartridge body 110 formed of a plastic material having an insulation property and a heat radiation property may be the first guide member 111 described above.

Accordingly, the heat generated in the terminal 12a and 12a of the pouch-type battery 10 during charging and discharging of the pouch-type battery 10 may be rapidly transferred toward the extension part 132 through the terminal parts 131 of the bus bars 130, and the heat being transferred toward the extension part 132 may be transferred toward the cartridge body 110 formed of a plastic material having an insulation property and a heat radiation property and then rapidly radiated.

Alternatively, the pouch-type battery cartridge 200 according to the embodiment of the present invention may further include a heat transfer sheet 140 stacked on one surface of the heat dissipation plate 120 to effectively dissipate the heat generated during charging and discharging of a battery.

In this case, the above description may be equally applied to the cartridge body 110, the heat dissipation plate 120, the bus bars 130, the elastic member 150, and the buffer member 160.

In detail, as illustrated in FIGS. 8 and 9, the heat transfer sheet 140 may be provided in the form of a plate-shaped sheet and may be disposed on one surface of the heat dissipation plate 120.

Accordingly, when two pouch-type batteries 10 are accommodated in the pouch-type battery cartridge 200, as illustrated in FIG. 12, any one of the two pouch-type batteries 10 may be in direct contact with the heat dissipation plate 120 and the other pouch-type battery 10 may be in direct contact with the heat transfer sheet 140 of the pouch-type battery cartridge 200 disposed adjacent thereto.

In detail, the heat transfer sheet 140 may include a first part 140a covering one surface of the first plate 121 and a second part 140b extending in one direction from an end of the first part 140a.

In this case, as illustrated in FIG. 12, the second part 140b may be in direct contact with the cooling unit 20 such as a heat exchanger, a cooling chamber, or a cooling plate.

Thus, the heat transfer sheet 140 may quickly dissipate the heat generated by the pouch-type batteries 10 accommodated in the adjacent pouch-type battery cartridge 200 and may quickly discharge the heat through the second part 140b in direct contact with the cooling unit 20.

In this case, the heat transfer sheet 140 may be formed of a material having a relatively higher thermal conductivity than that of the heat dissipation plate 120, and the heat transfer sheet 140 has one surface that may be attached to one surface of the heat dissipation plate 120 via an adhesive layer (not illustrated).

Thus, the heat generated by the two pouch-type batteries 10 accommodated in the same pouch-type battery cartridge 200 may be transferred toward the heat transfer sheet 140 through the heat dissipation plate 120 and then distributed, may be directly moved toward the heat transfer sheet 140 and distributed, and may be quickly radiated by the cooling unit 20 through the second part 40b of the heat transfer sheet 140. Thus, there may be no or minimal performance degradation of the pouch-type batteries 10 as a battery due to the heat.

As a non-limiting example, the heat transfer sheet 140 may be a graphite sheet 141, and the graphite sheet 141 may have an insulation-treated surface. Since the graphite sheet 141 has excellent electrical conductivity as well as high thermal conductivity, when the graphite sheet 141 is in direct contact with the pouch-type battery 10 and the heat dissipation plate 120, an electrical short may occur between the graphite sheet 141 and the pouch-type battery 10.

In order to prevent this phenomenon, in the present invention, when the heat transfer sheet 140 is provided as the plate-shaped graphite sheet 141, the graphite sheet 141 may have an insulation-treated surface. Thus, the heat transfer sheet 140 may prevent the possibility of occurrence of an electrical short due to electrical conductivity even while having high thermal conductivity for heat dissipation.

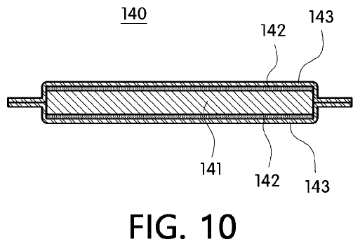

As another example, as illustrated in FIG. 10, the heat transfer sheet 140 may include the plate-shaped graphite sheet 141 and an insulating film member 143 that is attached to the graphite sheet 141 via an adhesive layer 142 and covers the surface of the graphite sheet 141.

Here, the insulating film member 143 may include a first insulating film member 143 covering the upper surface of the graphite sheet 141 and a second insulating film member 143 covering the lower surface of the graphite sheet 141, but the present invention is not limited thereto, and the insulating film member 143 may be configured as a single member.

Accordingly, the heat transfer sheet 140 may have high thermal conductivity by means of the graphite sheet 141 and, at the same time, have an insulation property by means of the insulating film member 143.

In this case, the adhesive layer 142 may contain a non-conductive component to further improve the insulation property.

The plurality of pouch-type battery cartridges 100 or 200 described above according to the embodiment of the present invention may be stacked in one direction to form one battery pack 1000.

That is, the plurality of pouch-type battery cartridges 100 or 200 may be fastened to each other in a state in which at least one pouch-type battery 10 is accommodated in the accommodation space S and stacked in the one direction. Thus, the one pouch-type battery pack 1000 may be configured.

In this case, the pouch-type battery 10 accommodated in any one pouch-type battery cartridge 100 or 200 among the plurality of pouch-type battery cartridges 100 or 200 may have one surface that is in direct contact with one surface of the heat dissipation plate 120 of the heat transfer sheet 140 provided in another pouch-type battery cartridges 100 or 200.

As an example, in the pouch-type battery pack 1000 according to the embodiment of the present invention, as illustrated in FIG. 13, the plurality of pouch-type battery cartridges 100 may be stacked in multiple stages in one direction, and the plurality of pouch-type battery cartridges stacked in multiple stages may be fixed to each other though the fastening bar 340 and a mounting frame 300.

In this case, in the pouch-type battery pack 1000, the first guide members 111 may be fixed to each other to face the lower side and the cooling unit 20 for cooling may be disposed below the first guide members 111.

To this end, in the pouch-type battery pack 1000, the bus bars 130, which are connected to at least one pouch-type battery 10 accommodated in each of the plurality of pouch-type battery cartridges 100 or 200, are electrically connected to each other, thereby increasing the total capacity.

Here, the pouch-type battery cartridges 100 or 200 and the pouch-type battery 10 are the same as those described above, and thus a detailed description thereof will be omitted.

As an example, the mounting frame 300 may be a frame structure surrounding the plurality of pouch-type battery cartridges 100 or 200 arranged adjacent to each other.

In detail, the mounting frame 300 may have a predetermined area so as to include a pair of support plates 310 and 320 arranged at front ends and rear ends of the plurality of pouch-type battery cartridges 100 or 200 arranged adjacent to each other, at least one fixing member 330 that connects the pair of support plates 310 and 320 to each other, and at least one fastening bar 340 that simultaneously fastens the plurality of pouch-type battery cartridges 100 or 200.

Here, the fastening bar 340 may have a predetermined length and may simultaneously pass through the fastening part 116 formed in each of the plurality of pouch-type battery cartridge 100 or 200.

Accordingly, the plurality of pouch-type battery cartridges 100 or 200 arranged adjacent to each other may be fixed to each other through the mounting frame 300.

Here, the support plates 310 and 320 may be in the form of a plate or may be a frame structure.

However, in the present invention, the mounting frame 300 is not limited thereto and may be various changed as long as the mounting frame 300 may fix the plurality of pouch-type battery cartridges 100 or 200 arranged adjacent to each other. As an example, the mounting frame 300 may be provided to have a housing shape accommodating the plurality of pouch-type battery cartridges 100 or 200 therein.

The pouch-type battery pack 1000 described above according to the embodiment of the present invention may be used as an energy supply source for various products such as electric vehicles, drones, portable phones, laptops, and digital cameras.

Although the embodiments of the present invention have been described above, the spirit of the present invention is not limited to the embodiments presented in the present specification. Those skilled in the art who understand the spirit of the present invention could easily propose other embodiments by adding, changing, deleting, adding, or the like of components within the same scope of the spirit. Further, these other embodiments also belong to the scope of the spirit of the present invention.

1. A pouch-type battery cartridge comprising:
a cartridge body that has an accommodation space with two open surfaces to accommodate at least one pouch-type battery and includes a first guide member facing a side surface of the pouch-type battery accommodated in the accommodation space;
a heat dissipation plate coupled to the cartridge body to cover one open surface of the accommodation space; and
a pair of bus bars coupled to one side of the cartridge body to be connected to a terminal of the pouch-type battery.

2. The pouch-type battery cartridge of claim 1, wherein the first guide member includes a plastic material having a heat radiation property and an insulation property.

3. The pouch-type battery cartridge of claim 1, wherein:
the cartridge body includes a second guide member, which is disposed to be spaced apart from the first guide member and faces the first guide member, and a pair of third and fourth guide members connecting both ends of the first guide member and both ends of the second guide member to each other; and
each of the first to fourth guide members includes a plastic material having a heat radiation property and an insulation property.

4. The pouch-type battery cartridge of claim 2, wherein the cartridge body includes at least one elastic member protruding from one surface of the first guide member toward the accommodation space, and
the elastic member is in contact with a side surface of the pouch-type battery when the pouch-type battery is accommodated in the accommodation space.

5. The pouch-type battery cartridge of claim 4, wherein:
the cartridge body has a predetermined area so as to include at least one arrangement hole formed to pass through the first guide member; and
the elastic member is coupled to the first guide member through the arrangement hole.

6. The pouch-type battery cartridge of claim 4, wherein the elastic member includes a polymer resin including thermally conductive fillers.

7. The pouch-type battery cartridge of claim 1, wherein the heat dissipation plate includes a first plate having a plate shape and covering one open surface of the accommodation space and a second plate extending in one direction from an end of the first plate to be in surface contact with one surface of the first guide member,
wherein the first plate is in surface contact with one surface of the pouch-type battery when the pouch-type battery is accommodated in the accommodation space.

8. The pouch-type battery cartridge of claim 1, wherein the heat dissipation plate is a plate-shaped metal plate.

9. The pouch-type battery cartridge of claim 1, wherein the bus bar includes a terminal part to which the terminal of the pouch-type battery is connected and an extension part extending in one direction from an end of the terminal part and disposed to be in contact with the first guide member.

10. The pouch-type battery cartridge of claim 1, further comprising a heat transfer sheet having a plate shape and disposed on one surface of the heat dissipation plate to be in surface contact with the heat dissipation plate.

11. The pouch-type battery cartridge of claim 10, wherein the heat transfer sheet is made of a material having a relatively higher thermal conductivity than the heat dissipation plate.

12. The pouch-type battery cartridge of claim 10, wherein the heat transfer sheet is a graphite sheet having an insulation-treated surface.

13. The pouch-type battery cartridge of claim 10, wherein the heat transfer sheet includes a graphite sheet having a plate shape and an insulating film member attached to the graphite sheet via an adhesive layer to cover a surface of the graphite sheet.

14. The pouch-type battery cartridge of claim 10, wherein the heat transfer sheet includes a first part disposed on a part, which covers one open surface of the accommodation space, of an entire area of the heat dissipation plate and a second part extending from the first part and covering a part, which is in surface contact with one surface of the first guide member, of the heat dissipation plate.

15. A pouch-type battery pack comprising:
a plurality of pouch-type battery cartridges, each of which is identical to the pouch-type battery cartridge of claim 1;
a plurality of pouch-type batteries accommodated in the accommodation space; and
a mounting frame that fixes the plurality of pouch-type battery cartridges stacked in one direction.
